(19) United States
(12) Patent Application Publication
(10) Pub. No.: US 2021/0382084 A1
(43) Pub. Date: Dec. 9, 2021

(54) LIDAR DEVICE AND AIR CONDITIONER

(71) Applicant: Mitsubishi Electric Corporation, Tokyo (JP)

(72) Inventor: Masaharu IMAKI, Tokyo (JP)

(73) Assignee: Mitsubishi Electric Corporation, Tokyo (JP)

(21) Appl. No.: 17/407,707

(22) Filed: Aug. 20, 2021

Related U.S. Application Data
(63) Continuation of application No. PCT/JP2019/011069, filed on Mar. 18, 2019.

(51) Int. Cl. G01P 5/26; G01S 7/481; G01S 17/95; B60H 1/00; G01S 17/58

(52) U.S. Cl. CPC G01P 5/26; G01S 7/4814; G01S 17/58; G01S 17/95; B60H 1/00735; G01S 7/4816

(57) ABSTRACT

The lidar device includes a multimode laser light source, a narrow-band filter for converting output laser light of the multimode laser light source into narrow-band laser light, an edge filter for receiving backscattered light generated when a target (Tgt) in an external space backscatters the narrow-band laser light, a light detection circuit for detecting a transmission light signal output by the edge filter and outputting an electric signal, and a signal processing unit for measuring at least a relative speed of the target (Tgt) on the basis of the electric signal. The light transmission characteristic of the narrow-band filter has a first narrow-band spectrum that forms a peak of light transmittance at a predetermined light transmission frequency, and the light transmission characteristic of the edge filter has a second narrow-band spectrum having an edge portion forming a positive or negative gradient of light transmittance at the light transmission frequency.

### CROSS REFERENCE TO RELATED APPLICATION

This application is a Continuation of PCT International Application No. PCT/JP2019/011069, filed on Mar. 18, 2019, which is hereby expressly incorporated by reference into the present application.

### TECHNICAL FIELD

The present invention relates to a lidar technique using laser light backscattered by a target.

### BACKGROUND ART

LAser Detection And Ranging (LADAR) technology using laser light is a technology that irradiates a target with the laser light and observes the target using the laser light backscattered by the target. LADAR using laser light is also called LIght Detection And Ranging (LIDAR), and is widely used in various technical fields such as wind measurement, distance measurement, and three-dimensional measurement. On the basis of the Doppler effect, a lidar called a Doppler lidar can measure a relative moving speed of a target using laser light backscattered by the target. As a method for detecting the Doppler effect, a coherent system using optical heterodyne detection and an incoherent system using an optical filter (direct detection system) are known. The edge technique, which is a type of incoherent system, is a technique of using an optical filter having a narrow-band light transmission characteristic with respect to the light frequency, and detecting the Doppler effect using an edge portion that is a rising or falling portion of the transmission spectrum of this optical filter.

Non-Patent Literature 1 below discloses a Doppler lidar that detects the relative moving speed of a target such as an aerosol or molecule in the atmosphere on the basis of the edge technique (see FIG. 1 of Non-Patent Literature 1). This Doppler lidar includes a narrow-band laser light source that outputs a laser light beam, a first detector that detects a part of the laser light beam, a telescope that receives backscattered light after transmitting the other part of the laser light beam into the atmosphere, an optical filter (edge filter) that transmits the backscattered light, a second detector that detects an optical signal output from the optical filter, and a calculator that calculates the relative moving speed of the target on the basis of the electric signals output by each of the first and second detectors.

### CITATION LIST

### Non-Patent Literature

Non-Patent Literature 1: C. Laurence Korb, Bruce M. Gentry, and Chi Y. Weng: “Edge technique: theory and application to the lidar measurement of atmospheric wind”, Appl. Opt. Vol. 31, pp. 4202-4213.

### SUMMARY OF INVENTION

### Technical Problem

In the conventional Doppler lidar, a single-mode laser light source operating in a single mode has been used because high-output laser light having a narrow spectral line width is required to ensure measurement accuracy. Further, in the case of a lidar device that measures the distance to a target using an optical pulse, the pulse width of the laser light is required to be short in order to obtain high distance resolution. However, there is a problem that it is difficult to achieve a single-mode laser light source that satisfies the conditions of short pulse width, narrow spectral line width, and high output with a semiconductor laser diode. Further, even if a single-mode laser light source satisfying such a condition can be achieved by a solid-state laser light source, there is a problem that it is difficult to miniaturize the lidar device because the size of the solid-state laser light source is large.

In view of the above, an object of the present invention is to provide a lidar device capable of measuring the relative speed of a target with high accuracy on the basis of the Doppler effect without using a single-mode laser light source, and an air conditioner having the lidar device.

### Solution to Problem

The lidar device according to an aspect of the present invention includes a multimode laser light source, a narrow-band filter for converting output laser light of the multimode laser light source into narrow-band laser light, an edge filter for receiving backscattered light generated when a target in an external space backscatters the narrow-band laser light after the narrow-band laser light is transmitted into the external space, a light detection circuit for detecting a transmission light signal output by the edge filter and generating an electric signal corresponding to the transmission light signal, and signal processing circuitry to measure at least a relative speed of the target on a basis of the electric signal, in which light transmission characteristic of the narrow-band filter has a first narrow-band spectrum that forms a peak of light transmittance at a predetermined light transmission frequency, light transmission characteristic of the edge filter has a second narrow-band spectrum having an edge portion forming a positive or negative gradient of light transmittance at the light transmission frequency, and the narrow-band filter and the edge filter are integrally formed.

### Advantageous Effects of Invention

According to an aspect of the present invention, the relative speed of a target can be measured with high accuracy without using a single-mode laser light source.

### BRIEF DESCRIPTION OF DRAWINGS

FIG. 1 is a functional block diagram showing a schematic configuration of a lidar device according to a first embodiment of the present invention.

FIG. 2 is a diagram schematically showing a configuration example of a Fabry-Perot interferometer type optical filter.

FIGS. 3A, 3C, and 3D are graphs schematically showing an example of an optical power spectrum, and FIG. 3B is a graph schematically showing an example of light transmission characteristics of the optical filter of the first embodiment.

FIG. 4 is a flowchart for explaining an example of an operation of the lidar device according to the first embodiment.

FIG. 5 is a functional block diagram showing a hardware configuration example of a signal processing unit of the first embodiment.

FIG. 6 is a functional block diagram showing an example of a schematic configuration of an air conditioner according to a second embodiment of the present invention.

FIG. 7 is a diagram showing a schematic configuration of an in-vehicle peripheral monitoring system according to a third embodiment of the present invention.

### DESCRIPTION OF EMBODIMENTS

Hereinafter, various embodiments according to the present invention will be described in detail with reference to the drawings. Note that components given the same reference numerals throughout the drawings have the same configuration and the same function.

### First Embodiment

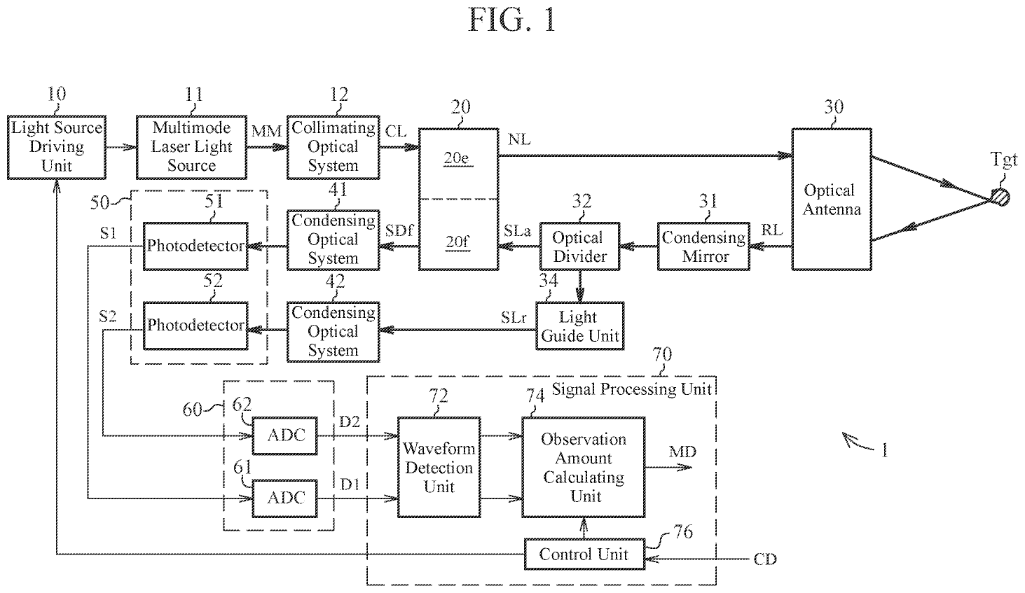

FIG. 1 is a functional block diagram showing a schematic configuration of a lidar device 1 according to a first embodiment of the present invention. The lidar device 1 shown in FIG. 1 includes a multimode laser light source 11 that operates in a vertical multimode, a light source driving unit 10 that drives the multimode laser light source 11 to output pulse laser light MM from the multimode laser light source 11, a collimating optical system 12 that converts the pulse laser light MM into parallel light CL, an optical filter 20 that converts the parallel light CL into narrow-band laser light NL, and an optical antenna (optical transmitter and receiver) 30 that transmits the narrow-band laser light NL to an external space.

The multimode laser light source 11 can be composed of a semiconductor laser diode (LD) capable of oscillating high-output laser light in a wide light frequency band. The multimode laser light source 11 is a high-output laser light source that can be obtained at a relatively low price as compared with the single-mode laser light source that operates in the vertical single mode.

The optical antenna 30 has a function of converting the narrow-band laser light NL input from the optical filter 20 into transmission light having a desired beam diameter and spread angle, and transmitting the transmission light toward a desired line-of-sight direction in the external space. Further, the optical antenna 30 can receive the backscattered light generated when the narrow-band laser light NL transmitted into the external space is backscattered by the target Tgt in a region to be measured as reception light RL. Further, the optical antenna 30 has an optical scanning function of scanning a predetermined range of the external space with the transmission light. As an element that implements such an optical scanning function, for example, one selected from among a group of parts such as a single or a plurality of wedge prisms, a galvanometer mirror, and a polygon mirror, or a combination of two or more parts selected from among the group of parts can be used.

Referring to FIG. 1, the lidar device 1 includes a condensing mirror 31 for condensing the reception light RL incident from the optical antenna 30, an optical divider 32 for dividing the reception light RL incident from the condensing mirror 31 into branched light signals SLa, SLr (first and second branched light signals), and a light guide unit 34 for guiding the branched light signal SLr.

The condensing mirror 31 has a function of condensing the reception light RL incident from the optical antenna 30 on the light input end of the optical divider 32. The optical divider 32 distributes the reception light RL to the branched light signals SLa, SLr, outputs the branched light signal SLa to the edge filter 20f of the optical filter 20, and at the same time outputs the branched light signal SLr to the light guide unit 34 as a reference light signal. The light guide unit 34 can guide the reference light signal SLr incident from the optical divider 32 to a condensing optical system 42. The light guide unit 34 may be composed of, for example, an optical lens and a reflection mirror, but is not limited thereto.

The optical filter 20 can convert the branched light signal SLa input from the optical divider 32 into a transmission light signal SDf having a transmission light intensity corresponding to a Doppler shift amount of the backscattered light. Here, the Doppler shift amount is a light frequency shift amount generated by the Doppler effect between the narrow-band laser light NL transmitted into the external space and the reception light RL. The detailed configuration of the optical filter 20 will be described later.

Referring to FIG. 1, the lidar device 1 further includes a condensing optical system 41 that condenses the transmission light signal SDf input from the optical filter 20, a condensing optical system 42 that condenses the reference light signal SLr incident from the light guide unit 34, a light detection circuit 50 that detects the transmission light signal SDf and the reference light signal SLr incident from the condensing optical systems 41, 42 and outputs the electric signals S1, S2 that are the detection results, an A/D conversion circuit 60 that converts the electric signals S1, S2 output from the light detection circuit 50 into digital detection signals D1, D2, and a signal processing unit 70 for measuring a relative speed (line-of-sight speed) of the target Tgt in the line-of-sight direction and a distance to the target Tgt on the basis of the digital detection signals D1, D2.

The optical filter 20 has two types of light transmission filters. One light transmission filter is a narrow-band filter 20e that converts parallel light CL in a predetermined light frequency band into narrow-band laser light NL in a narrower light frequency band. The other light transmission filter is an edge filter 20f that converts the branched light signal SLa input from the optical divider 32 into a transmission light signal SDf having a transmission light intensity corresponding to the Doppler shift amount. Such an optical filter 20 can be achieved by an optical interferometer such as a Fabry-Perot interferometer, a Michelson interferometer, a Fizeau interferometer, or a Mach-Zehnder interferometer.

Here, it is desirable that the narrow-band filter 20e and the edge filter 20f are integrally formed by using the same constituent materials in the same manufacturing process. As a result, even if the characteristics of the narrow-band filter 20e and the edge filter 20f change due to changes in the surrounding environment (for example, temperature changes) or deterioration of the optical filter 20 over time, since the difference in characteristics change between the narrow-band filter 20e and the edge filter 20f is small, deterioration of measurement accuracy can be suppressed.

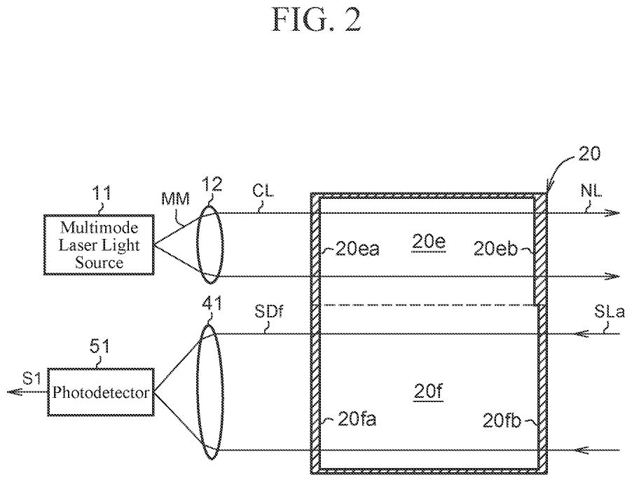

From the viewpoint of reducing the size of the optical filter 20, it is desirable that the optical filter 20 is implemented as a Fabry Perot Etalon. FIG. 2 is a diagram schematically showing a configuration example of the Fabry Perot Etalon type optical filter 20.

As shown in FIG. 2, the optical filter 20 includes a narrow-band filter 20e that transmits the input parallel light CL and an edge filter 20f that transmits the input branched light signal SLa. The narrow-band filter 20e has a pair of light reflecting surfaces 20ea, 20eb facing each other, and has an optical resonator structure that generates multiple reflections of input light between these light reflecting surfaces 20ea, 20eb. Similarly, the edge filter 20f has a pair of light reflecting surfaces 20fa, 20fh facing each other, and has an optical resonator structure that generates multiple reflections of input light between these light reflecting surfaces 20fa, 20fh.

The manufacturing process of the Fabry Perot Etalon type optical filter 20 is as follows, for example. First, a light transmitting substrate is formed by polishing the surface of a light transmitting base material such as quartz glass. Next, using a dielectric material, light reflecting films each having a predetermined light transmittance and light reflectance are formed on the front surface and the back surface of the light transmitting substrate. By individually controlling the thickness of the substrate in the formation region of the narrow-band filter 20e and the thickness of the substrate in the formation region of the edge filter 20f, the light transmission characteristics of the narrow-band filter 20e and the edge filter 20f can be individually adjusted. Alternatively, by individually controlling the thickness of the light reflecting film in the formation region of the narrow-band filter 20e and the thickness of the light reflecting film in the formation region of the edge filter 20f, the light transmission characteristics of the narrow-band filter 20e and the edge filter 20f can be also individually adjusted.

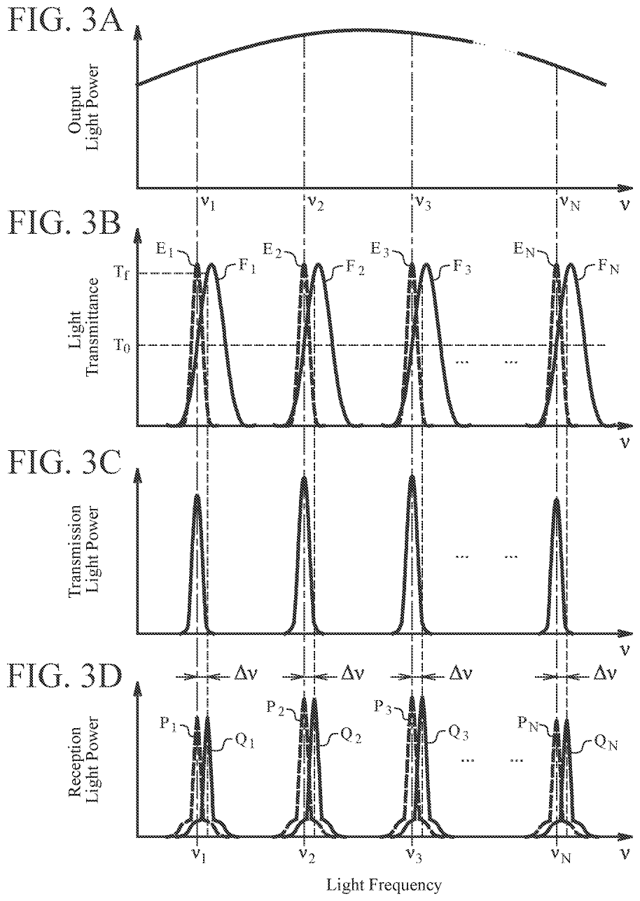

FIGS. 3A, 3C and 3D are graphs schematically showing an example of an optical power spectrum, and FIG. 3B is a graph schematically showing an example of the light transmission characteristics of the optical filter 20. In FIGS. 3A, 3C and 3D, the horizontal axis represents the light frequency v and the vertical axis represents the optical power. FIG. 3A shows an example of the optical power spectrum of the pulse laser light MM output from the multimode laser light source 11. In FIG. 3B, the horizontal axis represents the light frequency v, the vertical axis represents the light transmittance, the dotted line represents the transmission spectrum distribution of the narrow-band filter 20e, and the solid line represents the transmission spectrum distribution of the edge filter 20f FIG. 3C shows an example of the optical power spectrum of the transmission light, that is, the narrow-band laser light NL, and FIG. 3D shows an example of an optical power spectrum of the reception light RL when the Doppler shift amount Δv is zero and when the Doppler shift amount Δv is positive.

As illustrated in FIG. 3A, the light frequency band of the pulse laser light MM is distributed over a wide band. On the other hand, as shown by the dotted line in FIG. 3B, the light transmission characteristic of the narrow-band filter 20e has narrow-band spectra E₁, E₂, . . . , E_{N} that form sharp peaks (transmission peaks) of light transmittance at the light transmission frequencies v₁, v₂, . . . , v_{N} predetermined at the design stage of the optical filter 20. Here, the subscript N is a positive integer. The light transmission frequencies v₁, v₂, . . . , v_{N} are the center frequencies of the narrow-band spectra E₁, E₂, . . . , E_{N}, respectively. As shown in FIG. 3C, the spectral line width of the narrow-band laser light NL is narrower than the spectral line width of the pulse laser light MM, and can be set to, for example, a full width at half maximum of about several tens of MHz. Therefore, the narrow-band filter 20e can convert the wideband parallel light CL into the narrow-band laser light NL having the optical power spectrum shown in FIG. 3C. Further, the optical power spectrum of the narrow-band laser light NL forms sharp intensity peaks at light frequencies corresponding to each of the light transmission frequencies v₁, v₂, . . . , v_{N}.

As shown in FIG. 3B, the light transmission characteristic of the edge filter 20f has narrow-band spectra F₁, F₂, . . . , F_{N} with edge portions forming a positive gradient of light reflectance, respectively, at the light transmission frequencies v₁, v₂, . . . , v_{N}, which are the center frequencies of the narrow-band spectra E₁, E₂, . . . , E_{N}. Further, the light transmission characteristic of the narrow-band filter 20e is designed so that the light transmission frequencies v₁, v₂, . . . , v_{N} are almost the same as the light frequencies at the half value T₀ of the rising distribution of the narrow-band spectra F₁, F₂, . . . , F_{N}. Here, the half value T₀ is a value that is ½ of the maximum peak value of the narrow-band spectra F₁, F₂, . . . , F_{N}.

Note that, in the present embodiment, the narrow-band spectra F₁, F₂, . . . , F_{N} have edge portions that form a positive gradient of light transmittance at the light transmission frequencies v₁, v₂, . . . , v_{N}, but, it is not limited to this. An edge filter having a narrow-band spectrum having an edge portion forming a negative gradient of light transmittance at the light transmission frequencies v₁, v₂, . . . , v_{N} may be adopted. In this case, it is desirable that the light transmission frequencies v₁, v₂, . . . , v_{N} are designed to substantially coincide with the light frequencies at the half value T₀ of the falling distribution of the narrow-band spectrum of the edge filter.

FIG. 3D shows the narrow-band spectra P₁, P₂, . . . , P_{N} of the reception light RL when the Doppler shift amount Δv is zero, and the narrow-band spectra Q₁, Q₂, . . . , Q_{N} of the reception light RL when the Doppler shift amount Δv is positive. Each of the narrow-band spectra P₁ to P_{N} and Q₁ to Q_{N} includes a wide spectral line width scattered light component caused by Rayleigh scattering and a narrow spectral line width scattered light component caused by Mie scattering. In the present embodiment, a scattered light component having a narrow spectral line width due to Mie scattering is used.

When the Doppler shift amount Δv is zero, as shown in FIG. 3D, the peak light frequencies of the narrow-band spectra P₁, P₂, . . . , P_{N} of the reception light RL are almost the same as the light transmission frequencies v₁, v₂, . . . , v_{N}, respectively. In this case, the edge filter 20f outputs a transmission light signal SDf having a transmission light intensity corresponding to the light transmittance of the half value T₀ at the light transmission frequencies v₁, v₂, . . . , v_{N}.

Now, it is assumed that the light intensity or light amplitude of the transmission light signal SDf having the light frequency v is represented by Φ₁(v), and the light intensity or light amplitude of the reference light signal SLr is represented by Φ₂(v). Further, the signal ratio Φ(v) between the transmission light signal SDf and the reference light signal SLr is defined as shown in the following equation (1).

Φ(v)=Φ₁(v)/Φ₂(v) (1)

The signal ratio Φ(v) indicates the normalized light intensity or the normalized light amplitude of the transmission light signal SDf. The signal ratio Φ(v₀+Δv) when the Doppler shift amount Δv is generated with respect to the light frequency v₀ of the transmission light is as shown in the following equation (2).

Φ(v₀+Δv)=Φ₁(v₀+Δv)/Φ₂(v₀+Δv) (2)

When the Doppler shift amount Δv is positive, as shown in FIG. 3D, the peak light frequencies of the narrow-band spectra Q₁, Q₂, . . . , Q_{N} of the reception light RL are the same as the light frequencies v₁+Δv, v₂+Δv, . . . , v_{N}+Δv shifted to the positive side from the light transmission frequencies v₁, v₂, . . . , v_{N}, respectively. In this case, the edge filter 20f outputs a transmission light signal SDf having a transmission light intensity corresponding to the light transmittance of a value T_{f} larger than the half value T₀. Therefore, the signal ratio Φ(v₀+Δv) obtained when the Doppler shift amount Δv is positive is larger than the signal ratio Φ(v₀) obtained when the Doppler shift amount Δv is zero.

When the Doppler shift amount Δv is negative, each of the peak light frequencies of the narrow-band spectrum of the reception light RL are the same as the light frequencies shifted to the negative side from the light transmission frequencies v₁, v₂, . . . , v_{N}. In this case, the edge filter 20f outputs a transmission light signal SDf having a transmission light intensity corresponding to the light transmittance of a value smaller than the half value T₀. Therefore, the signal ratio Φ(v₀+Δv) obtained when the Doppler shift amount Δv is negative is smaller than the signal ratio Φ(v₀) obtained when the Doppler shift amount Δv is zero.

Referring to FIG. 1, the light detection circuit 50 is composed of photodetectors 51, 52. The photodetector 51 is a photoelectric conversion element that converts the transmission light signal SDf incident from the condensing optical system 41 into an electric signal S1, and the photodetector 52 is a photoelectric conversion element that converts the reference light signal SLr incident from the condensing optical system 42 into an electric signal S2. As such photodetectors 51, 52, for example, a PIN (P-Intrinsic-N) diode or an avalanche photo diode (APD) can be used. Each of the photodetectors 51, 52 can be configured to output an electric signal having a voltage value corresponding to the light intensity of the input light signal.

The A/D conversion circuit 60 has an A/D converter (ADC) 61 that generates a digital detection signal D1 by sampling the electric signal S1 at a predetermined sampling cycle, and an A/D converter (ADC) 62 that generates a digital detection signal D2 by sampling the electric signal S2 at a predetermined sampling cycle.

The signal processing unit 70 has a waveform detection unit 72 for detecting a signal waveform of the digital detection signal D1 and a signal waveform of the digital detection signal D2, an observation amount calculating unit 74 for calculating an observation value such as a relative speed of the target Tgt with respect to the lidar device 1 and a distance to the target Tgt, and a control unit 76 for controlling the operation of each of the light source driving unit 10 and the observation amount calculating unit 74. The control unit 76 has a function of executing control in response to a command signal CD supplied from the outside.

The waveform detection unit 72 detects the signal waveform of the digital detection signal D1, supplies data indicating the detected signal waveform to the observation amount calculating unit 74, detects the signal waveform of the digital detection signal D2, and supplies data indicating the detected signal waveform to the observation amount calculating unit 74. The observation amount calculating unit 74 can measure the distance to the target Tgt in the region to be measured in accordance with the TOF (Time-Of-Flight) method on the basis of the data supplied from the waveform detection unit 72.

Further, the observation amount calculating unit 74 detects a signal strength or signal amplitude of the digital detection signal D1 and a signal strength or signal amplitude of the digital detection signal D2, and can detect a relative speed of the target Tgt in the region to be measured on the basis of the detection result.

Now, the signal strength or signal amplitude of the digital detection signal D1 corresponding to the transmission light signal SDf having the light frequency v is represented by I₁(v), and the signal strength or signal amplitude of the digital detection signal D2 corresponding to the reference light signal SLr is represented by I₂(v). Further, the signal ratio I(v) between the digital detection signals D1, D2 is defined as shown in the following equation (3).

I(v)=I₁(v)/I₂(v) (3)

The signal ratio I(v) indicates the normalized signal strength or the normalized signal amplitude of the digital detection signal D1. When the Doppler shift amount Δv is generated with respect to the light frequency v₀ of the transmission light, the signal ratio I(v₀+Δv) is expressed by the following equation (4).

I(v₀+Δv)=I₁(v₀+Δv)/I₂(v₀+Δv) (4)

When the Doppler shift amount Δv is positive, the signal ratio I(v₀+Δv) is larger than the signal ratio I(v₀) obtained when the Doppler shift amount Δv is zero. On the contrary, when the Doppler shift amount Δv is negative, the signal ratio I(v₀+Δv) is smaller than the signal ratio I(v₀). Therefore, it can be seen that the Doppler shift amount Δv depends on the difference ΔI between the signal ratios represented by the following equation (5).

ΔI=I(v₀+Δv)−I(v₀) (5)

Here, the signal ratio I(v₀) when the Doppler shift amount Δv is zero can be measured in advance before the signal ratio I(v₀+Δv) is calculated.

It is known that the relative speed (line-of-sight speed) v of the target Tgt depends on the Doppler shift amount Δv as shown in the following equation (6).

Δv=(2v/c)×v₀ (6)

Here, c is the propagation speed of light.

Therefore, by preparing a conversion function or conversion table (look-up table) representing the relationship between the Doppler shift amount Δv and the difference ΔI in advance, the observation amount calculating unit 74 can calculate the relative speed v of the target Tgt by using the conversion function or conversion table and the equation (6).

When a proportional relationship (linear relationship) is established between the Doppler shift amount Δv and the difference ΔI, the observation amount calculating unit 74 can, for example, calculate the relative speed v of the target Tgt approximately by using the following equation (7).

v=(I/Θ)×ΔI/I(v₀) (7)

Here, Θ is a parameter called Doppler sensitivity.

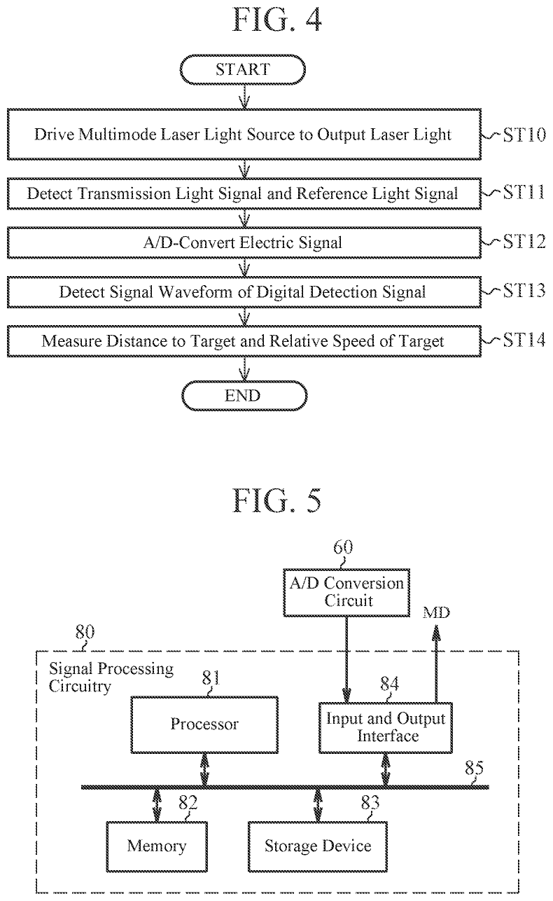

Next, the procedure of the observation operation of the lidar device 1 described above will be described with reference to FIG. 4. FIG. 4 is a flowchart for explaining an example of the observation operation of the lidar device 1.

Referring to FIG. 4, the light source driving unit 10 drives the multimode laser light source 11 to output the pulse laser light MM from the multimode laser light source 11 in accordance with the control by the control unit 76 of the signal processing unit 70 (step ST10). At this time, as described above, the collimating optical system 12 converts the pulse laser light MM into the parallel light CL, and the narrow-band filter 20e converts the wideband parallel light CL into the narrow-band laser light NL. Further, the optical antenna 30 converts the narrow-band laser light NL into transmission light having a desired beam diameter and spread angle, and transmits the transmission light toward a desired line-of-sight direction in the external space. When the backscattered light is received from the target Tgt, the optical antenna 30 outputs the reception light RL to the condensing mirror 31, and the optical divider 32 divides the reception light RL input via the condensing mirror 31 into the branched light signals SLa, SLr. The edge filter 20f converts the input branched light signal SLa into the transmission light signal SDf, and the condensing optical system 41 condenses the transmission light signal SDf on a light receiving region of the photodetector 51. Further, the light guide unit 34 guides the branched light signal SLr to the condensing optical system 42 as a reference light signal, and the condensing optical system 42 condenses the reference light signal SLr on a light receiving region of the photodetector 52.

Then, the photodetectors 51, 52 detect the transmission light signal SDf and the reference light signal SLr and output the electric signals S1, S2 (step ST11). Next, the A/D conversion circuit 60 converts the electric signals S1, S2 into the digital detection signals D1, D2 (step ST12).

After that, the waveform detection unit 72 detects the signal waveforms of the digital detection signals D1, D2 and supplies the detection result to the observation amount calculating unit 74 (step ST13). As described above, the observation amount calculating unit 74 measures the distance to the target Tgt in the region to be measured and the relative speed of the target Tgt on the basis of the detection result obtained in step ST13 (step ST14). The measurement data MD indicating the measurement result is output to the outside.

As described above, in the lidar device 1 of the first embodiment, as illustrated in FIG. 3B, the light transmission characteristic of the narrow-band filter 20e has narrow-band spectra (first narrow-band spectra) E₁, E₂, . . . , E_{N} that form sharp peaks of light transmittance at the light transmission frequencies v₁, v₂, . . . , v_{N}, and the light transmission characteristic of the edge filter 20f has narrow-band spectra (second narrow-band spectra) F₁, F₂, . . . , F_{N} with edge portions forming a positive gradient of light transmittance at the light transmission frequencies v₁, v₂, . . . , v_{N}, respectively. When the Doppler shift amount Δv is generated, accordingly, the light transmission intensity of the transmission light signal SDf output from the edge filter 20f changes depending on the Doppler shift amount Δv, and thus, the signal processing unit 70 can measure the relative speed of the target Tgt on the basis of the signal waveform of the digital detection signal D1 corresponding to the transmission light signal SDf. Therefore, the lidar device 1 of the first embodiment can measure the relative speed of the target Tgt with high accuracy on the basis of the Doppler effect by using the multimode laser light source 11 without using the single-mode laser light source. High distance resolution can also be ensured by using the multimode laser light source 11 capable of oscillating high-output laser light having a short pulse width.

Further, since the relatively low-priced multimode laser light source 11 is used, the manufacturing cost of the lidar device 1 can be reduced to a lower cost. Further, by using a semiconductor laser diode as the multimode laser light source 11, it is possible to provide a small and inexpensive lidar device 1.

Note that, all or part of the above-described functions of the signal processing unit 70 can be implemented, for example, by one or more processors having a semiconductor integrated circuit, such as a digital signal processor (DSP), an application specific integrated circuit (ASIC) or a field-programmable gate array (FPGA). Alternatively, all or part of the functions of the signal processing unit 70 may be implemented by one or more processors including an arithmetic unit, such as a central processing unit (CPU) or a graphics processing unit (GPU) that executes program codes of software or firmware. Alternatively, all or part of the functions of the signal processing unit 70 can also be implemented by one or more processors including a combination of a semiconductor integrated circuit such as DSP, ASIC or FPGA and an arithmetic unit such as CPU or GPU.

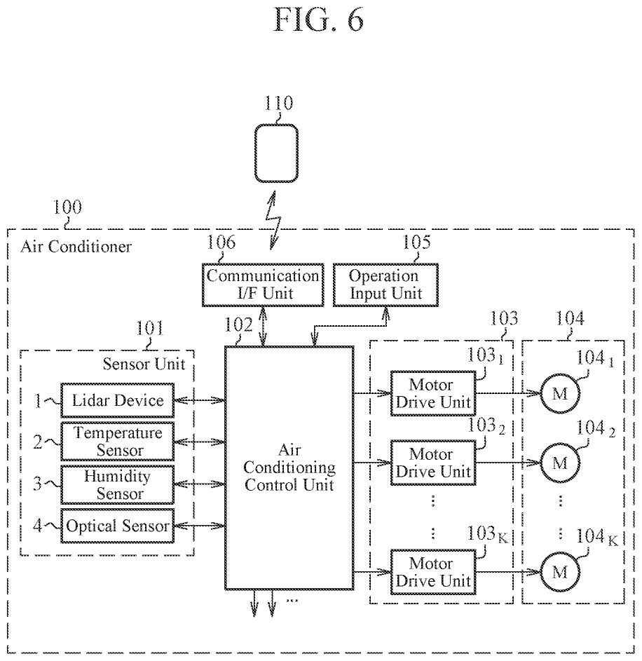

FIG. 5 is a functional block diagram showing a schematic configuration of signal processing circuitry 80, which is an example of the hardware configuration of the signal processing unit 70 of the first embodiment. The signal processing circuitry 80 shown in FIG. 5 includes a processor 81, an input and output interface 84, a memory 82, a storage device 83, and a signal path 85. The signal path 85 is a bus for connecting the processor 81, the input and output interface 84, the memory 82, and the storage device 83 to each other. The input and output interface 84 has a function of transferring the digital detection signals D1, D2 input from the A/D conversion circuit 60 to the processor 81, and also has a function of outputting the measurement data MD transferred from the processor 81 to the outside.

The memory 82 includes a work memory used when the processor 81 executes digital signal processing, and a temporary storage memory in which data used in the digital signal processing is loaded. For example, the memory 82 may be composed of a semiconductor memory such as a flash memory and SDRAM (Synchronous Dynamic Random Access Memory). Further, when the processor 81 includes an arithmetic unit such as a CPU or GPU, the storage device 83 can be used as a storage region for storing program codes of software or firmware to be executed by the arithmetic unit. For example, the storage device 83 may be composed of a non-volatile semiconductor memory such as a flash memory or a ROM (Read Only Memory).

Note that, in the example of FIG. 5, the number of processors 81 is one, but the number is not limited to this. The hardware configuration of the signal processing unit 70 may be achieved by using a plurality of processors that operate in cooperation with each other.

### Second Embodiment

The lidar device 1 described above can be applied to aircraft, vehicles, meteorological observation systems, wind power generation systems, and air conditioning (air conditioning) systems. FIG. 6 is a functional block diagram showing an example of a schematic configuration of an air conditioner 100 according to a second embodiment of the present invention. The lidar device 1 of the first embodiment is incorporated in the air conditioner 100.

The air conditioner 100 shown in FIG. 6 includes a sensor unit 101 that observes the airflow, air temperature, humidity, and the state of an object in the region to be measured in the external space, a blower mechanism 104 that generates a temperature-controlled airflow in the external space, a drive unit 103 that drives the blower mechanism 104, an air conditioning control unit 102 that controls the operation of the sensor unit 101 and the drive unit 103, a communication interface (I/F) unit 106 that controls infrared communication or wireless communication between the air conditioning control unit 102 and a remote controller 110, and an operation input unit 105. The operation input unit 105 includes a display that displays the operating state of the air conditioner 100, and an input device such as a button, a switch, or a touch panel for the user to operate.

The blower mechanism 104 has various drive motors 104₁ to 104_{K} (K is an integer equal to or more than 2) for driving these air-conditioning parts in addition to air-conditioning parts (not shown) such as a blower, a heat exchanger, a blower fan, and a wind direction plate. The drive unit 103 has motor control units 103₁ to 103_{K} for driving the drive motors 104₁ to 104_{K}, respectively.

The sensor unit 101 includes a lidar device 1 that detects the state of airflow (for example, wind speed and direction) in the region to be measured in the external space, a temperature sensor 2 that measures the temperature in the external space, a humidity sensor 3 that measures the humidity in the external space, and an optical sensor 4 that detects the presence or absence of an object such as a human in the external space. The air conditioning control unit 102 can control the blower mechanism 104 by controlling the operation of the drive unit 103 on the basis of the detection result by the sensor unit 101. For example, when the sensor unit 101 detects a wind direction in the region to be measured, the air conditioning control unit 102 can control the blower mechanism 104 to control the blowing direction on the basis of the detected value (wind direction value) of the wind direction.

As described above, since the air conditioner 100 of the second embodiment includes the lidar device 1 of the first embodiment, the size of the sensor unit 101 can be reduced. Further, the air conditioning control unit 102 can detect and control the state of the air flow in the external space with high accuracy on the basis of the detection result by the lidar device 1.

### Third Embodiment

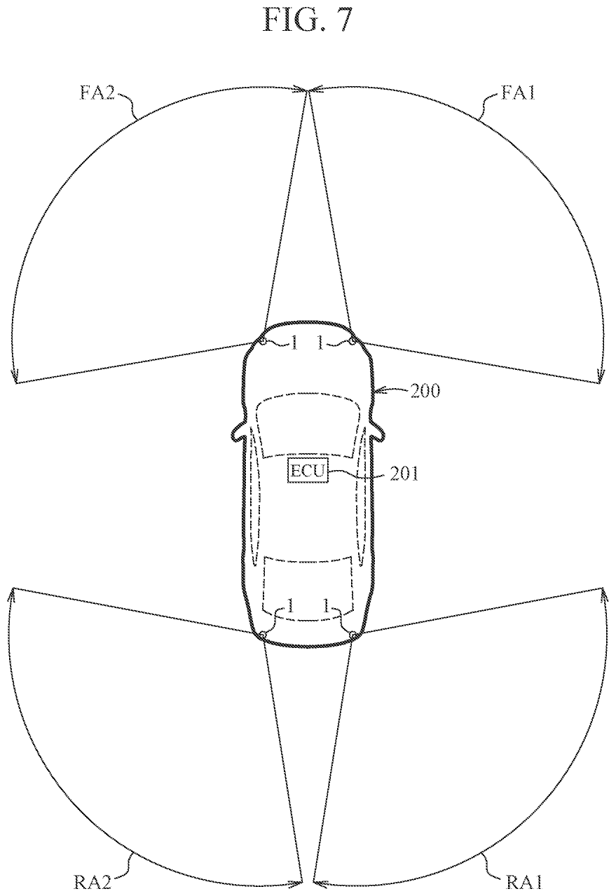

FIG. 7 is a diagram showing a schematic configuration of an in-vehicle peripheral monitoring system according to a third embodiment of the present invention. The in-vehicle peripheral monitoring system shown in FIG. 7 includes four lidar devices 1,1,1, and 1 that scan the peripheral regions FA1, FA2, RA1, and RA2 of a vehicle 200, and a monitoring ECU (Electronic Control Unit) 201 that monitors the peripheral regions FA1, FA2, RA1, and RA2 using the detection result by these lidar devices 1,1,1, and 1. In the example of FIG. 7, the lidar devices 1, 1, 1, and 1 are mounted on the corners of the main body of the vehicle 200, but the mounting position of the lidar device 1 is not limited to the position shown in FIG. 7.

Since the size of the lidar device 1 of the first embodiment is small and the price of the lidar device 1 can be reduced, it is easy to mount a large number of lidar devices 1 on the vehicle 200, and it is possible to reduce the cost of the in-vehicle peripheral monitoring system.

Although the first to third embodiments according to the present invention have been described above with reference to the drawings, the first to third embodiments are examples of the present invention, and various embodiments other than the first to third embodiments are available. Within the scope of the present invention, free combinations of the first to third embodiments, deformation of any component of each embodiment, or omission of any component of each embodiment are possible.

For example, the lidar device 1 of the first embodiment performs, but is not limited to, measurement based on the edge technique using one edge filter 20f to detect the Doppler effect. Instead of one edge filter 20f, a plurality of edge filters may be used to detect the Doppler effect.

### INDUSTRIAL APPLICABILITY

The lidar device according to the present invention enables high-precision measurement using a multimode laser light source, and is therefore suitable to be used in, for example, aircraft, mobile vehicles, meteorological observation systems, wind power generation systems, and air conditioning (air conditioning) systems.

### REFERENCE SIGNS LIST

1: lidar device, 2: temperature sensor, 3: humidity sensor, 4: optical sensor, 10: light source driving unit, 11: multimode laser light source, 12: collimating optical system, 20: optical filter, 20e: narrow-band filter, 20f: edge filter, 30: optical antenna (optical transmitter and receiver), 31: condensing mirror, 32: optical divider, 34: light guide unit, 41, 42: condensing optical system, 50: light detection circuit, 51, 52: photodetector, 60: A/D conversion circuit, 61, 62: analog-to-digital converter (ADC), 70: signal processing unit, 72: waveform detection unit, 74: observation amount calculating unit, 76: control unit, 80: signal processing circuitry, 81: processor, 82: memory, 83: storage device, 84: input and output interface, 85: signal path, 100: air conditioner, 101: sensor unit, 102: air conditioning control unit, 103: drive unit, 103₁ to 103_{K}: motor control unit, 104: blower mechanism, 104₁ to 104_{K}: drive motor, 105: operation input unit, 106: communication interface unit, 110: remote controller, 200: vehicle, 201: monitoring ECU, Tgt: target.

1. A lidar device comprising:
a multimode laser light source;
a narrow-band filter for converting output laser light of the multimode laser light source into narrow-band laser light;
an edge filter for receiving backscattered light generated when a target in an external space backscatters the narrow-band laser light after the narrow-band laser light is transmitted into the external space;
a light detection circuit for detecting a transmission light signal output by the edge filter and generating an electric signal corresponding to the transmission light signal; and
signal processing circuitry to measure at least a relative speed of the target on a basis of the electric signal, wherein
light transmission characteristic of the narrow-band filter has a first narrow-band spectrum that forms a peak of light transmittance at a predetermined light transmission frequency,
light transmission characteristic of the edge filter has a second narrow-band spectrum having an edge portion forming a positive or negative gradient of light transmittance at the light transmission frequency, and
the narrow-band filter and the edge filter are integrally formed.

2. The lidar device according to claim 1, wherein a spectral line width of the narrow-band laser light is narrower than a spectral line width of the output laser light.

3. The lidar device according to claim 1, further comprising:
an optical divider for dividing the backscattered light into a first-branched light signal and a second-branched light signal and outputs the first-branched light signal to the edge filter, wherein
the edge filter converts the first-branched light signal into the transmission light signal,
the light detection circuit detects the second-branched light signal and generates an electric signal corresponding to the second-branched light signal, and
the signal processing circuitry measures at least a relative speed of the target on a basis of the electric signal corresponding to the transmission light signal and the electric signal corresponding to the second-branched light signal.

4. The lidar device according to claim 1, wherein the light transmission frequency coincides with a light frequency at half of the maximum peak value of the second narrow-band spectrum.

5. The lidar device according to claim 1, wherein each of the narrow-band filter and the edge filter includes an optical interferometer.

6. The lidar device according to claim 5, wherein the optical interferometer is a Fabry-Perot interferometer.

7. The lidar device according to claim 6, wherein the Fabry-Perot interferometer has a pair of light reflecting surfaces facing each other and has a resonance structure for generating multiple reflections between the pair of light reflecting surfaces.

8. The lidar device according to claim 1, wherein
the multimode laser light source outputs an optical pulse as the output laser light; and
the signal processing circuitry measures a distance to the target on a basis of the electric signal in accordance with a Time-Of-Flight (TOF) method.

9. An air conditioner comprising:
a sensor including a lidar device according to claim 1;
a driver for driving a blower mechanism that controls an airflow in the external space; and
an air conditioning controller for controlling an operation of the driver using a measurement result by the signal processing circuitry.
